(19) United States
(12) Patent Application Publication
(10) Pub. No.: US 2008/0262641 A1
(43) Pub. Date: Oct. 23, 2008

(54) METHOD AND APPARATUS FOR PLAYING BACK CONTENTS IN A MOBILE COMMUNICATION TERMINAL

(75) Inventors: Yeong Gyun YOU, Suwon-si (KR); Jong Kerl LEE, Gumi-si (KR); Keon Young PARK, Busan (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/062,331

(22) Filed: Apr. 3, 2008

(30) Foreign Application Priority Data
Apr. 17, 2007 (KR) 2007-0037205

(51) Int. Cl. G06F 3/048; G06F 17/00

(52) U.S. Cl. 700/94; 715/853

(57) ABSTRACT

An apparatus and method for playing back contents in a mobile communication terminal are provided. The apparatus and method easily search for content and play back the searched contents based on items in a mobile communication terminal. The method includes displaying classification items, which are hierarchically associated with each other, in response to a request for displaying a contents list, selecting one of the classification items, and, if the selected classification item has a sub-hierarchy associated therewith, displaying detail items corresponding to the sub-hierarchy, or if the selected classification item is the lowest hierarchy, displaying all contents in the selected classification item. Therefore, the users can easily search for, select, and play back their desired contents according to various items.

### PRIORITY

This application claims the benefit under 35 U.S.C. § 119(a) of a Korean patent application filed on Apr. 17, 2007 in the Korean Intellectual Property Office and assigned Serial No. 2007-0037205, the entire disclosure of which is hereby incorporated by reference.

### BACKGROUND OF THE INVENTION

1. Field of the Invention

The present invention relates to a mobile communication terminal. More particularly, the present invention relates to a method and apparatus that can easily search for contents and play back the searched contents based on items in a mobile communication terminal.

2. Description of the Related Art

In general, a mobile communication terminal is a device that can provide personal portability and various functions, such as wireless communication, using an application program. Such a mobile communication terminal includes personal mobile communication services terminals, personal digital assistants (PDA's), smart phones, international mobile telecommunication 2000 (IMT-2000) terminals, wireless LAN terminals and the like.

With the rapid development of communications technology, this mobile communication terminal can now provide a variety of added functions, such as a video call function, an electronic pocket notebook function, voice or image storage function, Internet function, games and a contents playback function, as well as the conventional functions, such as voice calling and short text message transmission. In particular, the contents playback function serves to play back sound sources (for example, MP3, WMA, OGG, etc.) or video contents (for example, AVI, MPG, WMV, etc.), which are stored in the mobile communication terminal, using a content playback unit mounted on the mobile communication terminal.

As the mobile communication terminal increases its storage capacity and process ability, various contents can be stored and played back and thus the size of the contents is also gradually increased.

However, as the mobile communication terminal stores increasing amount of varied contents, this causes a problem since it takes additional time for users to locate the desired contents. Also, the conventional mobile communication terminal does not classify and display the stored contents based on artist or album classification. Therefore, although users wish to play back the contents according to artists or albums, the conventional mobile communication terminal cannot meet the users' needs.

### SUMMARY OF THE INVENTION

An aspect of the present invention is to address at least the above-mentioned problems and/or disadvantages and to provide at least the advantages described below. Accordingly, an aspect of the present invention is to provide an apparatus and method that allows users to easily search for contents and to play back their preferred contents based on items in a mobile communication terminal.

In accordance with an aspect of the present invention, a method for playing back contents in a mobile communication terminal is provided. The method includes displaying classification items, which are hierarchically associated with each other, in response to a request for displaying a contents list, selecting one of the classification items, and if the selected classification item has a sub-hierarchy associated therewith, displaying detail items corresponding to the sub-hierarchy, or if the selected classification item is the lowest hierarchy, displaying all contents in the selected classification item.

In accordance with another aspect of the present invention, a method for playing back contents in a mobile communication terminal is provided. The method include displaying at least two classification items, which are hierarchically associated with each other, in response to a request for displaying a contents list, displaying detail items of one item selected from the classification items, if one item selected from the detail items has a sub-hierarchy, displaying sub-detail items of the sub-hierarchy, and if there is a request for playing back one of the classification items, the detail items, and the sub-detail items, playing back contents corresponding to the requested item.

In accordance with another aspect of the present invention, a mobile communication terminal is provided. The mobile terminal includes a list processing unit for displaying a classification list including classification items hierarchically associated with each other in response to a list display request, for displaying detail items of a selected classification item in response to a request for displaying the selected classification, for determining whether a selected detail item has sub-detail items according to a request for displaying sub-detail items, and for displaying a corresponding sub-detail item if the selected detail item has sub-detail items, a key input unit for inputting a request for playing back one selected from the classification items, the detail items, and the sub-detail items, and a content playback unit for playing back contents corresponding to the playback-requested item.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiment of the present invention will become more apparent from the following detailed description in conjunction with the accompanying drawings, in which:

FIG. 1 is a schematic block diagram illustrating a mobile communication terminal according to an exemplary embodiment of the present invention;

FIGS. 2A to 2D are flowcharts describing a method for playing back contents in a mobile communication terminal according to an exemplary embodiment of the present invention;

FIGS. 3A to 3F are screens to describe a method for playing back contents in a mobile communication terminal according to an exemplary embodiment of the present invention; and

FIG. 4 is a view illustrating a hierarchical item structure of a method for playing back contents in a mobile communication terminal according to an exemplary embodiment of the present invention.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Although the drawings represent certain exemplary embodiments of the invention, the drawings are not necessarily to scale and certain features may be exaggerated or omitted in order to better illustrate and explain the present invention.

In certain exemplary embodiments of the present invention, contents include sound source contents, such as MP3 and WMA, and video contents, such as AVI, WMV, and ASF, etc., which can be played back by a content playback unit.

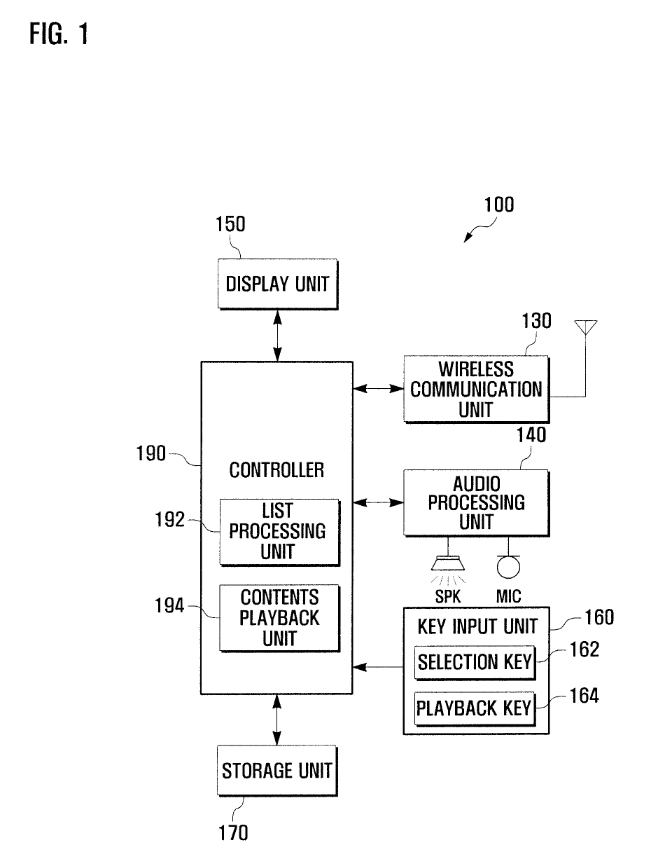

FIG. 1 is a schematic block diagram illustrating a mobile communication terminal according to an exemplary embodiment of the present invention.

Referring to FIG. 1, the mobile communication terminal 100 includes a wireless communication unit 130, an audio processing unit 140, a key input unit 160, a display unit 150, a storage unit 170, and a controller 190.

The wireless communication unit 130 allows the mobile communication terminal 100 to transmit and receive data through wireless communication. The wireless communication unit 130 is configured to include an RF transmitter for upconverting the frequency of transmitted signals and amplifying the transmitted signal, and an RF receiver for low-noise amplifying a received RF signal and down-converting the frequency of the received RF signal. The wireless communication unit 130 receives data through an RF channel and outputs the data to the controller 190. In addition, the wireless communication unit 130 transmits the data output from the controller 190 through the RF channel.

The audio processing unit 140 may be configured to include a codec (coder & decoder). The codec may be configured to include a data codec that processes packet data and an audio codec that processes audio signals, such as voice signals. The audio processing unit 140 converts the digital audio data, received by the controller 190 through the wireless communication unit 130 during a call, into an analog audio signal to output the signal through a speaker SPK using the audio codec. Furthermore, the audio processing unit 140 converts an analog audio signal, input through a microphone MIC, into digital audio signal to output the signal to the controller 190 using the audio codec.

The key input unit 160 inputs a user's operation signal for controlling the mobile communication terminal 100 and outputs the signal to the controller 190. The key input unit 160 is configured to include control keys (not shown) for controlling operations of the mobile communication terminal 100 and a plurality of alphanumeric keys (not shown) for inputting letters and numbers. In addition, the key input unit 160, according to an exemplary embodiment of the present invention, includes a selection key 162 and a playback key 164.

The selection key 162 serves to select an item on which the cursor is placed while contents are searched in a list. When a particular item is selected through the selection key 162, its detail items are displayed.

The playback key 164 serves to play back an item on which the cursor is placed. When the playback key 164 is operated in a state where the cursor is on a particular item, all of its contents are played back.

Although the selection key 162 and playback key 164 use keys implemented in hardware in the exemplary embodiment of the present invention, it should be understood that they can be implemented in software.

The display unit 150 serves to display a contents list on the screen, using data output from the controller 190. The display unit 150 is implemented by a liquid crystal display (LCD) device which includes an LCD controller, a memory for storing data, and an LCD panel. Furthermore, if the LCD device is implemented having a touch screen function, the screen of the display unit 150 may serve as an input unit.

The storage unit 170 includes a program memory and a data memory. The program memory stores programs for controlling operations of the mobile communication terminal 100. The data memory stores data created while the programs are executed. Also, the storage unit 170 stores a variety of contents.

The controller 190 controls the entire operation of the mobile communication terminal 100. The controller 190 includes a list processing unit 192 and a contents playback unit 194, thereby selecting and playing back contents in the mobile communication terminal.

The list processing unit 192 displays a list including corresponding items in response to a request for displaying a contents list and also in response to an item selection.

The contents playback unit 194 sequentially plays back contents starting from the content of an item on which the cursor is presently placed when a user inputs a request for playing back contents.

The following is a description of a method for playing back contents in a mobile communication terminal. During the description of the method, the configuration of the mobile communication terminal 100 described above will become more apparent.

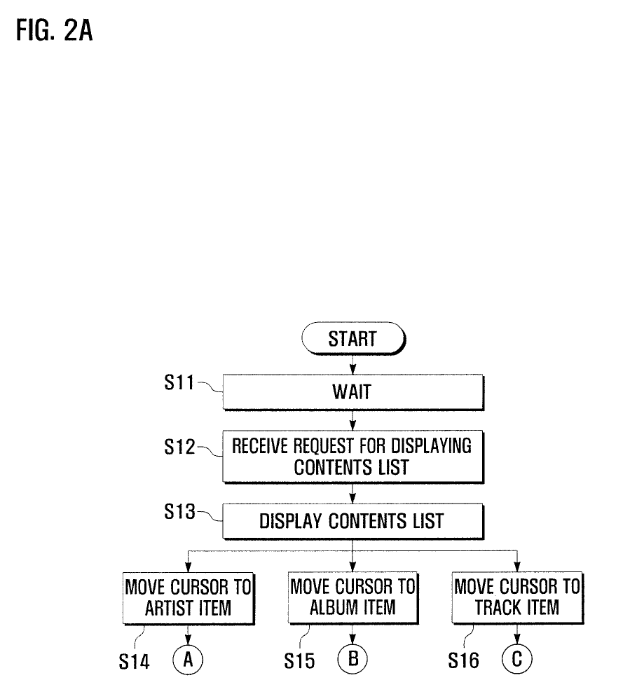

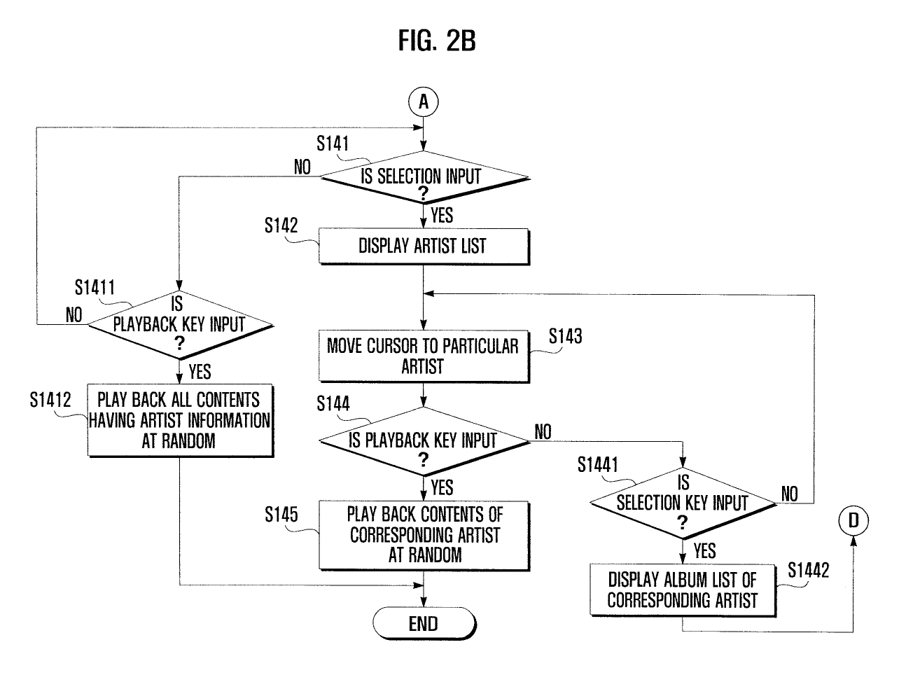

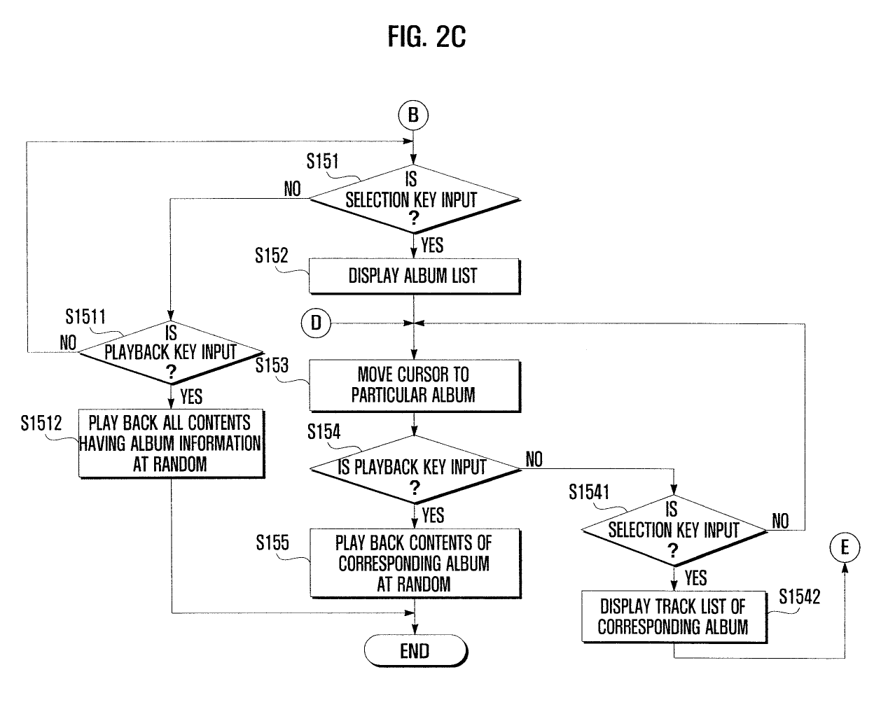

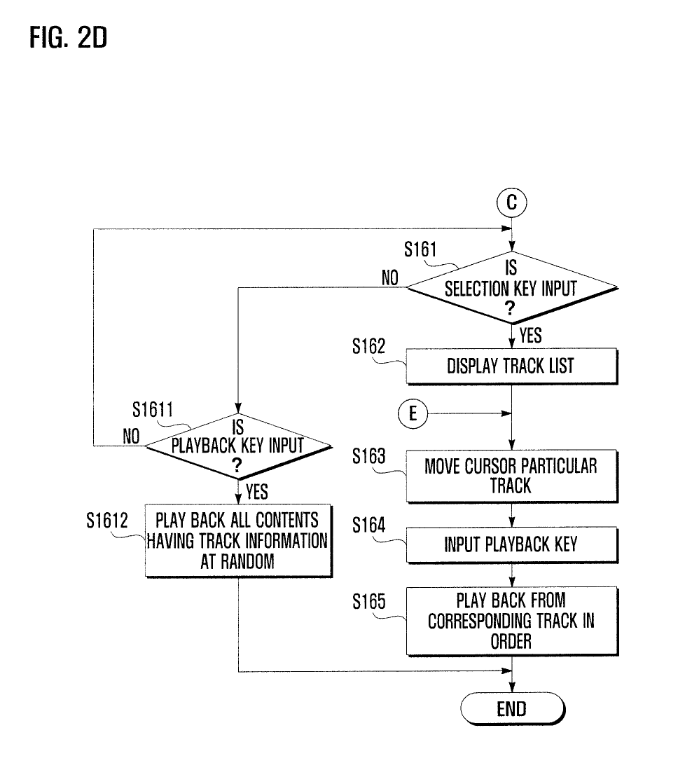

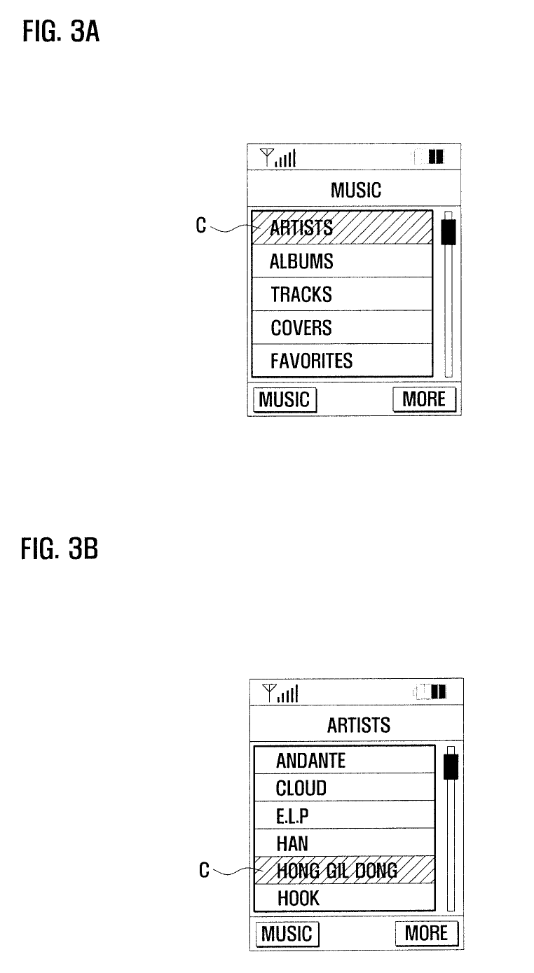

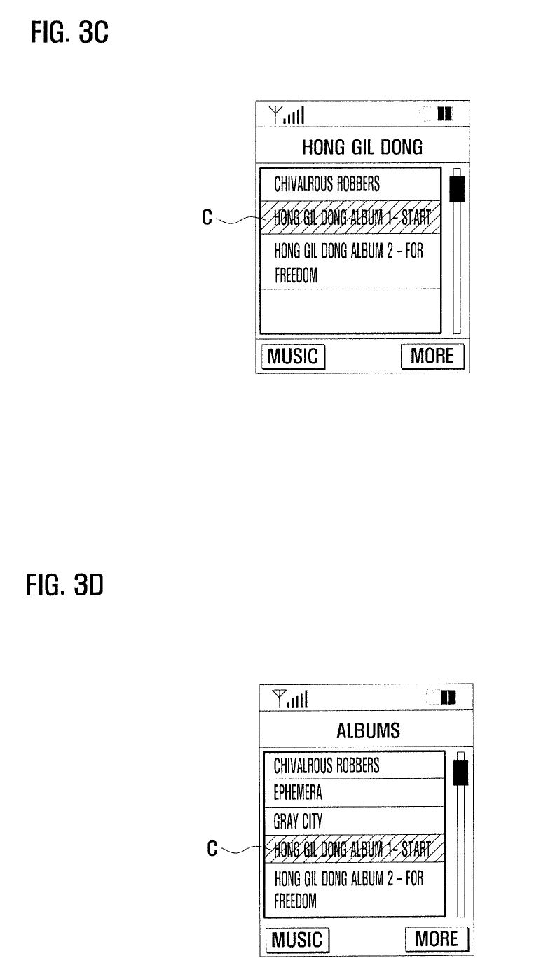

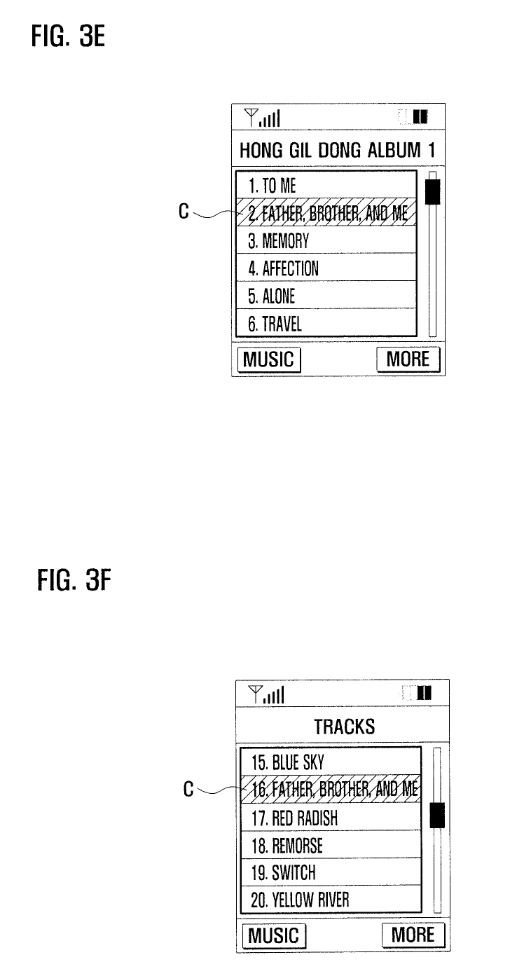

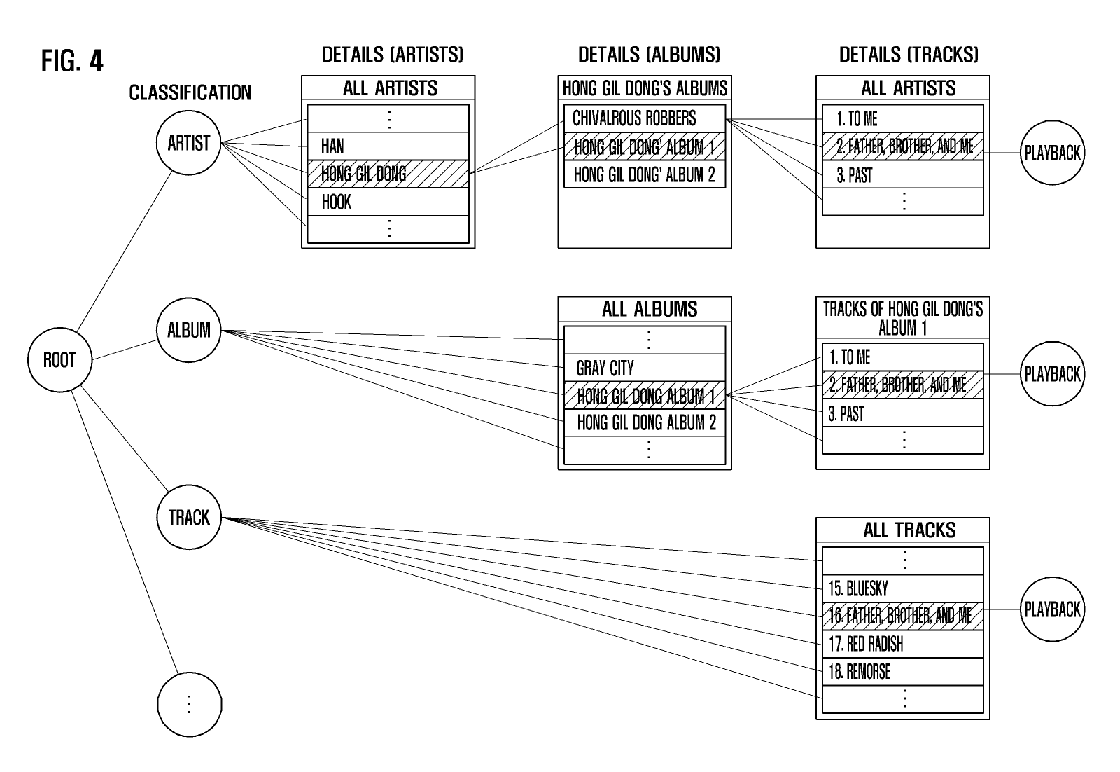

FIGS. 2A to 2D are flowcharts describing a method for playing back contents in a mobile communication terminal according to an exemplary embodiment of the present invention. FIGS. 3A to 3F are screens to describe a method for playing back contents in a mobile communication terminal according to an exemplary embodiment of the present invention. FIG. 4 is a view illustrating a hierarchical item structure of a method for playing back contents in a mobile communication terminal according to an exemplary embodiment of the present invention.

As shown in FIG. 2A, when the mobile communication terminal 100 is in a wait state at step S11, a request for displaying a contents list by user's key operation is input at step S12. The list processing unit 192 of the controller 190 displays a classification list including a plurality of classification items as shown in FIG. 3A at step S13, which will be described in detail below.

Referring to FIG. 4, the item hierarchical structure of an exemplary embodiment of the present invention includes a classification list, a detail list and a sub-detail list.

The classification list includes a list displayed when the user requests a display of the contents list. More specifically, the classification list includes a plurality of classification items, for example, an artist item, an album item and a track item.

The detail list includes a list displayed when the user selects one of the classification items in the classification list. More specifically, the detail list includes a plurality of detail items, for example, an artist name, an album name and a track name.

The sub-detail list includes a list displayed when the user selects one of the detail items in the detail list. More specifically, the sub-detail list includes the detail items which are hereinafter referred as sub-detail items for convenient description.

The classification items, such as an artist item, an album item, and a track item, are hierarchically associated with each other. An exemplary embodiment of the present invention configures a hierarchy of a plurality of classification items in such a way that an artist item is the highest level, an album item is a sub-hierarchy of the artist item, and a track item is a sub-hierarchy of the album item. In this example, the track item is the lowest level.

In the case that an artist item is selected as one of the classification items, all artists are displayed as detail items of the artist item. When one of the detail items (i.e., an artist) is selected, the sub-detail item (i.e., an album item) of the selected detail item is displayed. Here, the album item as the sub-detail item displays only the albums of the selected artist, not the albums of all the artists.

Each album has a track item as its sub-hierarchy. When one of the albums from the album item is selected, tracks corresponding to the selected album are displayed in the track item.

Similarly, in the case that an album item is selected as one of the classification items, all albums are displayed as the detail items of the album item. When one of the detail items (i.e., an album) is selected, the sub-detail item (i.e., a track item) of the selected detail item is displayed. Here, the track item as the sub-detail item displays only the tracks of the selected album.

In the case that a track item is selected as one of the classification items, all tracks are displayed since the track item is at the lowest level without having a sub-hierarchy.

As shown in FIG. 3A, the items in the classification list include an artist item, an album item, a track item, a cover item and a favorite item. The classification list may include a variety of items, such as a playlist item, an audio book item, a genre item and the like. Although this application will not describe all of the variety of items and their hierarchical structure, they can be implemented in the same manner as the exemplary embodiment of the present invention. The exemplary embodiment of the present invention will be described using three classification items such as an artist item, an album item and a track item, which are hierarchically associated with each other, for conciseness and convenience of description.

When the classification list is displayed at step S13, the user places the cursor C on his/her desired classification item through the key input unit 160 at steps S14, S15 and S16.

FIG. 3A is a screen where the cursor C is placed on the artist item, so that the user selects and plays back contents in the artist item.

After the user places the cursor C on the artist item at step S14, the playback key 164 and selection key 162 are activated such that they may be used to operate the device by providing user input. As shown in FIG. 2B, when an input is made with the selection key 162 at step S141, the list processing unit 192 detects the input of the selection key 162, extracts content information (e.g., artist information) from contents stored in the mobile communication terminal, and displays a detail list including detail items (names of various artists), as shown in FIG. 3B, at step S142. Here, the content information (e.g., artist information, album information, and track information) is extracted based on information stored in ID3 tags of the respective contents. In an exemplary implementation, the content information is entered in the database and stored in the storage unit 170 such that searches can be carried out more efficiently.

The user then places the cursor C on one of the artists in the detail list at step S143.

When the cursor C is located on the user's desired artist (e.g., Hong Gil Dong), the list processing unit 192 waits for an input of the playback key 164 or the selection key 162. When input of the playback key 164 is made at step S144, the content playback unit 194 plays back all contents when the artist (Hong Gil Dong) of the artist item is matched with artist information at step S145.

An exemplary embodiment of the present invention may be implemented in such a way that all contents with which the items (classification items and detail items) selected by the cursor C is matched can be played back at random if the playback key 164 is input. Therefore, the content playback unit 194 plays back all contents stored in the mobile communication terminal at random, provided that the artist information of the contents to be played back has the artist's name of “Hong Gil Gong.”

This process is identically applied to the case of the classification item. With reference again to step S141, if a selection input is not made with the selection key 162, it is then determined whether a playback input is made with playback key 164 at step S1411. That is, if the user places the cursor C on the artist item of the classification list and inputs the playback key 164 at step S1411, the contents playback unit 194 plays back, at random, contents having artist information, stored in the mobile communication terminal at step S1412. Although the exemplary embodiment of the present invention is implemented in such a way to play back contents at random, it should be understood that the present invention is not limited thereto. For example, the exemplary embodiment may be modified to play back contents from the most recent date or according to a title sequence.

In an exemplary embodiment of the present invention, contents matched with detail items selected by a user are played back at random. However, the respective detail items (Hong Gil Dong, and Hook) are played back in order starting from the selected detail item (Hong Gil Dong) to the detail items located below the selected detail item. For example, if contents, matched with the artist Hong Gil Dong selected by the user, are all played back, the content playback unit 194 automatically plays back the next artist, Hook, as one of the detail items, located below the artist, Hong Gil Dong. As in the case of Hong Gil Dong, all contents, matched with the artist Hook, are played back at random.

Meanwhile, if the user inputs the selection key 162 at step S1441 instead of inputting the playback key 164 at step S144, the list processing unit 192 displays the album item as the sub-detail item of the artist item. That is, as shown in FIG. 3C, the sub-detail list displays sub-detail items (e.g., albums of the artist, Hong Gil Dong, located by the cursor) at step S1442. Here, the displayed sub-detail list displays only albums that include at least one matched with the artist Hong Gil Dong.

After that, by following path “D” as illustrated in FIG. 2C, the contents may be selected through the album item and played back at step S155, as described below.

Referring again to FIG. 2A, when the classification list is displayed at step S13, the user locates the cursor C on the album item at step S15, and then inputs the playback key 164 or selection key 162. As shown in FIG. 2C, when the selection key 162 is input at step S151, the list processing unit 192 detects the input of the selection key 162, extracts content information (e.g., album information) from contents stored in the mobile communication terminal, and displays a detail list including detail items (all albums), as shown in FIG. 3D, at step S152. Here, the content information (e.g., album information) is extracted based on information stored in ID3 tags of the respective contents. In an exemplary implementation, the content information (album information) is entered in the database and stored in the storage unit 170 such that searches can be carried out more efficiently.

The user then places the cursor C on one of the albums in the detail list at step S153.

When the mobile communication terminal performs from step S15 to step S153, all albums are displayed on the screen of the display unit 150 as a detail list. In contrast, when the procedure moves from step S1442 of FIG. 2B to step S153 of FIG. 2C, only albums of a corresponding artist, as the sub-detail list, are displayed on the screen of the display unit 150.

As such, although the mobile communication terminal displays different album lists on the screen of the display unit 150 according to whether the albums are requested to be displayed from the artist item in the detail list or the album item in the classification list, the above two modes identically perform the following processes.

When the user places the cursor C on a particular album (e.g., Hong Gil Dong's album 1), the list processing unit 192 determines whether a playback key 164 or a selection key 162 is input. If the playback key 164 is input at step S154, the content playback unit 194 plays back, at random, all contents matched with Hong Gil Dong's album 1 on which the cursor C is placed at step S155.

Similar to the description of the artist item, the respective detail items (Chivalrous Robbers, Hong Gil Dong's albums 1, and albums 2) are played back from the selected detail item (Hong Gil Dong's album 1) to the next detail items (Hong Gil Dong's album 2) in order at step S155. For example, when contents matched with Hong Gil Dong's album 1 selected by the user are all played back, the content playback unit 194 automatically starts to play back Hong Gil Dong's album 2 following to Hong Gil Dong' album 1. Following the pattern of Hong Gil Dong's album 1, the contents of Hong Gil Dong's album 2 are played back at random.

Following the same pattern as the description of the artist item, when the user places the cursor C on the album item in the classification list and inputs the playback key 164 at step S1511, the contents list 194 plays back, at random, all contents that have album information in the mobile communication terminal at step S1512.

In contrast, when the user inputs the selection key 162 at step S1541, the list processing unit 192 displays tracks of an album (e.g., Hong Gil Dong's album 1), on which the cursor C is placed, in the sub-detail list as shown in FIG. 3E at step S1542. Here, the sub-detail list displays only the contents matched with Hong Gil Dong's album 1.

The procedure after step S1542 follows similar processes in that content is selected from the track item and then played back, which will be described below with reference to FIG. 2D.

As shown in FIG. 2A, the user may place the cursor C on the track item displayed in the classification list at step S16. Referring to FIGS. 2D and 3F, when the user inputs a selection key 162 at step S161, the list processing unit 192 detects the input of the selection key 162 and displays all contents as a detail list (i.e., track list) stored in the mobile communication terminal at step S162. The track information may be a title of the content and can be extracted from information stored in ID3 tags of the contents, respectively.

The user then moves the cursor to his/her desired track at step S163.

When the mobile communication terminal performs from step S16 to step S163, the track information of all contents is displayed on the screen of the display unit 150 in a detail list. In contrast, when the procedure moves from step S1542 to step S163, only the contents of the album selected through step S1541 are displayed on the screen of the display unit 150, in a sub-detail list.

As such, although the mobile communication terminal displays the different track lists on the screen of the display unit 150 depending on individual processes, the above modes identically perform the following processes.

When the user places the cursor C on a particular track (e.g., Father, Brother, and Me in FIG. 3E), the list processing unit 192 waits for the input of the playback key 164. If the playback key 164 is input at step S164, the content playback unit 194 plays back the content “Father, Brother, and Me” on which the cursor is placed at step S165. After playing back the content “Father, Brother, and Me,” the content playback unit 194 plays back in order the other content (e.g., Memory, or Red Radish as shown in FIG. 3F).

In contrast, when the selection key 162 is not input at step S161, the controller 190 waits for an input at step S1611. When the playback key 164 is input at step S1611, the contents playback unit 194 detects the input of the playback key 164 and plays back all contents having the track information at random at step S1612

That is, an exemplary embodiment of the present invention may be implemented in such a way that, when the user selects and plays back the contents (e.g., tracks), the contents can not be played back at random but are sequentially played back starting from the selected content to next contents. However, although the exemplary embodiment plays back the contents in order, it should be understood that the present invention is not limited thereto.

As described in the foregoing, the method and apparatus according to certain exemplary embodiments of the present invention use a hierarchical structure whose items are hierarchically associated with each other to play back the contents of the items in the mobile communication terminal, thereby allowing the user to select his/her desired contents through a variety of paths.

For example, when a user knows the name of his/her desired playback content, he/she directly accesses and selects the content (e.g., a track of the track item in the classification list) to play it back. In contrast, when the user does not know the name of his/her desired playback contents, he/she searches for the contents from the artists or from the albums. That is, if the user only knows the name of an artist, he/she accesses the artist item and selects the album including the contents from albums related to the artist. Similarly, if the user only knows the title of an album, he/she directly accesses the album item and searches for the album (contents).

Since the method and apparatus of exemplary embodiments the present invention can input playback commands for all items displayed on the display unit, users can play back contents based on items such as artists, albums and tracks.

Although certain exemplary embodiments of the present invention have been described in detail hereinabove, it should be understood by those skilled in the art that various changes in form and details may be made therein without departing from the spirit and scope of the present invention as defined in the appended claims and their equivalents.

For example, although an exemplary embodiment of the present invention is implemented in such a way that, when a particular item is selected and replayed, the contents matched with the item are played back at random, it should be understood that the invention is not limited thereto but can be modified such that the contents are played back according to the recent playback sequence or higher playback frequency. Also, although the method and apparatus of the present invention are implemented based on a mobile communication terminal, it should be understood that they can be applied to all electronic devices or digital devices that can play back contents. In addition, although exemplary embodiments of the present invention are described based on three items, an artist, an album, and a track, it should be understood that the present invention is not limited to them, but can be modified in such a way that the contents can be played back based on various items, such as, covers, favorites, play lists, audio books, album issue years, online broadcasts, genres, etc.

As described above, the method and apparatus of the present invention allows users to easily search for their desired contents according to various items, and to play them back in the mobile communication terminal. Also, the method and apparatus of the present invention can play back contents based on various items.

What is claimed is:

1. A method for playing back contents in a mobile communication terminal, the method comprising:
displaying classification items, which are hierarchically associated with each other, in response to a request for displaying a contents list;
selecting one of the classification items; and
if the selected classification item has a sub-hierarchy associated therewith, displaying detail items corresponding to the sub-hierarchy, or if the selected classification item is the lowest hierarchy, displaying all contents of the selected classification item.

2. The method of claim 1, further comprising playing back contents corresponding to the selected classification item in response to a request for playing back the selected classification item.

3. The method of claim 2, further comprising if one of the displayed detail items is selected and the selected detail item has another sub-hierarchy, displaying another detail items corresponding to the another sub-hierarchy of the selected detail item.

4. The method of claim 3, further comprising if the selected detail item is the lowest sub-hierarchy, displaying the contents of the selected detail item.

5. The method of claim 2, wherein the playing back of the contents comprises playing back the contents corresponding to the selected classification item at random.

6. The method of claim 4, further comprising playing back contents of the selected detail item at random in response to a request for playing back the selected detail item.

7. The method of claim 2, wherein the classification item comprises at least one of an artist item, an album item and a track item, in which the track item has the lowest hierarchy.

8. The method of claim 7, further comprising, if the artist item is selected, displaying artists as the detail item of the artist item in a list.

9. The method of claim 8, further comprising, if one of the artists in the list is selected, displaying albums of the selected artist as the detail item of the album item.

10. The method of claim 4, further comprising playing back the contents from the selected content in order in response to a request for playing back the selected content.

11. A method for playing back contents in a mobile communication terminal, comprising:
displaying at least two classification items, which are hierarchically associated with each other, in response to a request for displaying a contents list;
displaying detail items of one item selected from the classification items;
if the one item selected from the detail items has its sub-hierarchy, displaying sub-detail items of the sub-hierarchy; and
if there is a request for playing back at least one of the classification items, the detail items, and the sub-detail items, playing back contents corresponding to the requested item.

12. The method of claim 11, wherein the classification items comprise at least one of an artist item, an album item and a track item.

13. The method of claim 12, wherein the playing back of the contents comprises playing back the contents of one item selected from the items at random.

14. The method of claim 12, wherein the classification items further comprise at least one of a cover item, a favorite item, a playlist item, an audio book item and a genre item.

15. The method of claim 12, wherein, if the artist item is selected from the classification items, the displaying of the detail items comprises displaying artists as the detail item of the artist item in a list.

16. The method of claim 15, wherein, if one of the artists in the list is selected, the displaying of the sub-detail items comprises displaying albums of the selected artist as the sub-detail items of the detail item.

17. The method of claim 16, wherein, if one of the displayed albums is selected, the displaying of the sub-detail items further comprises displaying contents of the selected album.

18. The method of claim 12, wherein, if the album item is selected from the classification items, the displaying of the detail items comprises displaying albums as contents, listed in the album item.

19. The method of claim 18, wherein, if one of the albums displayed in the list is selected, the displaying of the sub-detail items further comprises displaying contents of the selected album.

20. The method of claim 12, wherein, if the track item is selected from the classification items, the displaying of the detail items comprises displaying all contents in a list.

21. The method of claim 12, wherein, if all of the contents corresponding to a particular item are played back, the playing back of the contents comprises playing back contents of an item adjacent to the particular item.

22. The method of claim 12, wherein the request for play back of the sub-detail items and the playing back of the sub-detail items are repeatedly performed depending on whether their sub-hierarchies exist.

23. A mobile communication terminal comprising:
a list processing unit for displaying a classification list including classification items hierarchically associated with each other in response to a list display request, for displaying detail items of a selected classification item in response to a request for displaying the selected classification, for determining whether a selected detail item has sub-detail items according to a request for displaying sub-detail items, and for displaying a corresponding sub-detail item if the selected detail item has sub-detail items;
a key input unit for inputting a request for playing back one selected from the classification items, the detail items, and the sub-detail items; and
a content playback unit for playing back contents corresponding to the playback-requested item.

24. The terminal of claim 23, wherein the content playback unit plays back contents corresponding to the selected particular item at random.

25. The terminal of claim 23, wherein the classification items comprises at least one of an artist item, an album item and a track item.
